(19) United States
(12) Patent Application Publication
(10) Pub. No.: US 2013/0035858 A1
(43) Pub. Date: Feb. 7, 2013

(54) Navigation Device, Guidance Method Thereof and Route Search Method Thereof

(71) Applicants: Akio Sumizawa, Kanagawa, (JP); Hideo Fujiwara, Kanagawa (JP); Satoshi Kurihara, Kanagawa (JP); Arata Hayashi, Tokyo (JP)

(72) Inventors: Akio Sumizawa, Kanagawa, (JP); Hideo Fujiwara, Kanagawa (JP); Satoshi Kurihara, Kanagawa (JP); Arata Hayashi, Tokyo (JP)

(73) Assignee: Clarion Co., Ltd., Saitama-shi (JP)

(21) Appl. No.: 13/519,351

(22) PCT Filed: Dec. 27, 2010
(86) PCT No.: PCT/JP2010/073615

§ 371 Date: Oct. 4, 2012

(30) Foreign Application Priority Data
Dec. 28, 2009 (JP) 2009-298078
Dec. 28, 2009 (JP) 2009-298085

(51) Int. Cl. G01C 21/34

(52) U.S. Cl. 701/533

(57) ABSTRACT

Disclosed is navigation technology for providing guidance for HOV lanes in a more readily understandable manner. A navigation device is provided with: a storage unit adapted to store, for each predetermined segment of road, lane information including whether or not it is possible to enter or exit lanes which can be used when a predetermined condition is fulfilled (hereafter referred to as conditional lanes); a route search unit adapted to search for a recommended route to a destination; and a lane guidance unit adapted to provide entry/exit guidance in a road segment where a conditional lane can be entered or exited. If a segment where a conditional lane can be exited and a segment where the conditional lane can be entered, which is before the segment which can be exited, are on the recommended route, the lane guidance unit provides entry guidance in the segment where the lane can be entered.

### TECHNICAL FIELD

The present invention relates to a technique for a navigation device. The present invention claims the priorities of Japanese Patent Application Nos. 2009-298078 and 2009-298085 both filed on Dec. 28, 2009, whose contents are incorporated herein by reference as for the designated countries that permit it.

### BACKGROUND ART

Conventionally, a navigation device employs a route guidance technique adapted for a traffic lane (such as a High-Occupancy Vehicles (HOV) lane) in which vehicles satisfying specific conditions are allowed to travel. Patent Document 1 describes a technique for such a navigation device. An HOV lane is also called a carpool lane.
Patent Document 1: Japanese Unexamined Patent Laid-Open No. 2008-286671
Patent Document 2: Japanese Unexamined Patent Laid-Open No. 2000-131085

### DISCLOSURE OF THE INVENTION

Navigation devices as described in the above-mentioned Patent Documents 1 and 2, however, cannot necessarily perform adequate guidance into an HOV lane.

An object of the present invention is to provide a navigation technique of performing guidance into an HOV lane in a more understandable manner.

To solve the above problem, the present invention provides a navigation device relating to a point (hereinafter, referred to as “first point of the invention”) that a user can easily grasp entrances and exits to use for traveling along a recommended route. Thus, the present invention provides a navigation device, comprising: a storage unit adapted to store, for each prescribed section of a road, lane information including information on possibility of entry and exit to and from a lane (hereinafter, referred to as conditional lane) that is available for traveling when prescribed conditions are satisfied; a route search unit adapted to search for a recommended route to a designated destination; and a lane guidance unit adapted to perform guidance about entrance into or exit from the conditional lane at a road section that allows entrance and exit to and from the conditional lane; and if there are an exit-allowing section from the conditional lane and an entrance-allowing section into the conditional lane before the exit-allowing section on the recommended route, the lane guidance unit adapted to perform entrance guidance into the conditional lane at the entrance-allowing section.

Further, the present invention provides a navigation device relating to a point (hereinafter, referred to as “second point of the invention”) that guidance is performed along a suitable route including a lane (hereinafter, referred to a conditional lane) that is available for traveling when prescribed conditions are satisfied. Thus, the present invention provides a navigation device, comprising: a storage unit adapted to store lane information including information on a state of setting-up of a lane (hereinafter, referred to as conditional lane) that is available for traveling when prescribed conditions are satisfied; a route search unit adapted to perform a search for a recommended route to a destination by using the lane information; and a route verification unit adapted to verify whether the recommended route retrieved by the route search unit includes a lane change prohibition section (i.e. a section other than an exit from the conditional lane) through which it is necessary to exit from the conditional lane; and in the case where the recommended route includes the lane change prohibition section, the route search unit performs again a search for a route that avoids the lane change prohibition section.

According to the present invention, it is possible to provide a technique of performing guidance about an HOV lane in a more understandable manner.

### BRIEF DESCRIPTION OF DRAWINGS

FIG. 1 is a schematic block diagram showing a navigation device;

FIG. 2 is a diagram showing structure of a link table;

FIG. 3 is a diagram showing structure of an exit guidance management table;

FIG. 4 is a view showing a mounting position of a camera;

FIG. 5 is a view showing a state in which a taken image is projected on the ground surface;

FIG. 6 is a functional block diagram showing a processing part;

FIG. 7 is a flowchart showing HOV guidance processing;

FIGS. 8A and 8B are views showing an example of a guidance screen displayed by the HOV guidance processing;

FIG. 9 is a view illustrating a specific example of the HOV guidance processing;

FIG. 10 is a view illustrating a specific example of the HOV guidance processing;

FIG. 11 is a schematic block diagram showing a navigation device;

FIG. 12 is a diagram showing structure of a link table;

FIG. 13 is a view showing a mounting position of a camera;

FIG. 14 is a view showing a state in which a taken image is projected on the ground surface;

FIG. 15 is a functional block diagram showing a processing part;

FIG. 16 is a flowchart showing route search processing;

FIG. 17 is a flowchart showing HOV-priority route verification processing;

FIGS. 18A and 18B are views illustrating HOV-priority route verification processing with a specific example; and

FIG. 19 is a flowchart showing a variation of HOV-priority route verification processing.

### BEST MODE FOR CARRYING OUT THE INVENTION

Now, a navigation device to which an embodiment relating to the first point of the present invention is applied will be described referring to drawings.

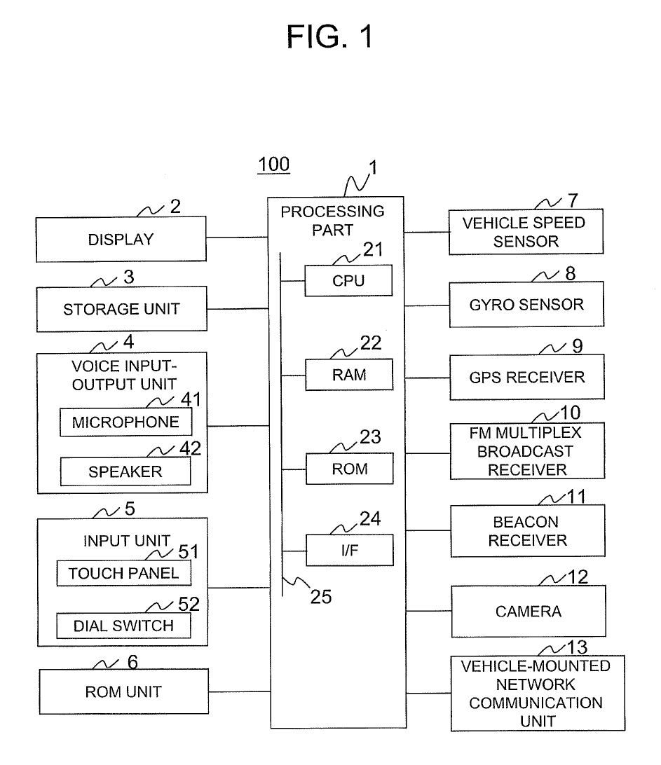

FIG. 1 is a diagram showing a general configuration of a navigation device 100. As a so-called navigation device, the navigation device 100 can display map information to indicate a point denoting the current location of the navigation device 100 and information for guidance along a route to an already-set destination.

The navigation device 100 comprises a processing part 1, a display 2, a storage unit 3, a voice input-output unit 4 (having a microphone 41 as a voice input unit and a speaker 42 as a voice output unit), an input unit 5, a ROM unit 6, a vehicle speed sensor 7, a gyro sensor 8, a Global Positioning System (GPS) receiver 9, an FM multiplex broadcast receiver 10, a beacon receiver 11, a camera 12, and a vehicle-mounted network communication unit 13.

The processing part 1 is a central unit that performs various types of processing. For example, the processing part 1 calculates a current location on the basis of information outputted from the various types of sensors 7, 8, the GPS receiver 9, the FM multiplex broadcast receiver 10 and the like. Further, based on the obtained current location information, the processing part 1 reads out map data required for display from the storage unit 3 or the ROM unit 6.

Further, the processing part 1 expands the read map data into graphics, superimposes a mark denoting the current location on the graphics, and displays the resultant graphics on the display 2. Further, by using map data and the like stored in the storage unit 3 or the ROM unit 6, the processing part 1 searches for the optimum route (recommended route) connecting a departure place designated by the user or the current location to a destination (or a way point or a stopover point). Further, the processing part 1 guides the user by using the speaker 42 and/or the display 2.

Further, as described below, the processing part 1 can guide driving at an entrance/exit of a High-Occupancy Vehicles (HOV) lane in the course of route guidance. An HOV lane is a lane for which it is prescribed that only a vehicle carrying at least a prescribed number of passengers (for example, two including a driver) or a vehicle satisfying specific criteria (such as fuel efficiency standards or low-pollution criteria) can travel in it.

The processing part 1 of the navigation device 100 is constructed by connecting component devices through a bus 25. The processing part 1 comprises: a Central Processing Unit (CPU) 21, which executes various types of processing such as numerical operation and control of each component device; a Random Access Memory (RAM) 22 for storing map data, operation data and the like read from the storage unit 3; a Read Only Memory (ROM) 23 for storing programs and data; and an interface (I/F) 24 for connecting various hardware units with the processing part 1.

The display 2 is a unit for displaying graphics information generated by the processing part 1 or the like. The display 2 comprises a liquid crystal display, an organic EL display, or the like.

The storage unit 3 comprises a storage medium that is at least readable-writable, such as a Hard Disk Drive (HDD), a nonvolatile memory card, or the like.

This storage medium stores a link table 200, i.e. map data (including link data on links as components of each road on a map) required for an ordinary route search device and an exit guidance management table 250 for specifying location of an exit from an HOV lane on a recommended route and necessity of guidance about the exit.

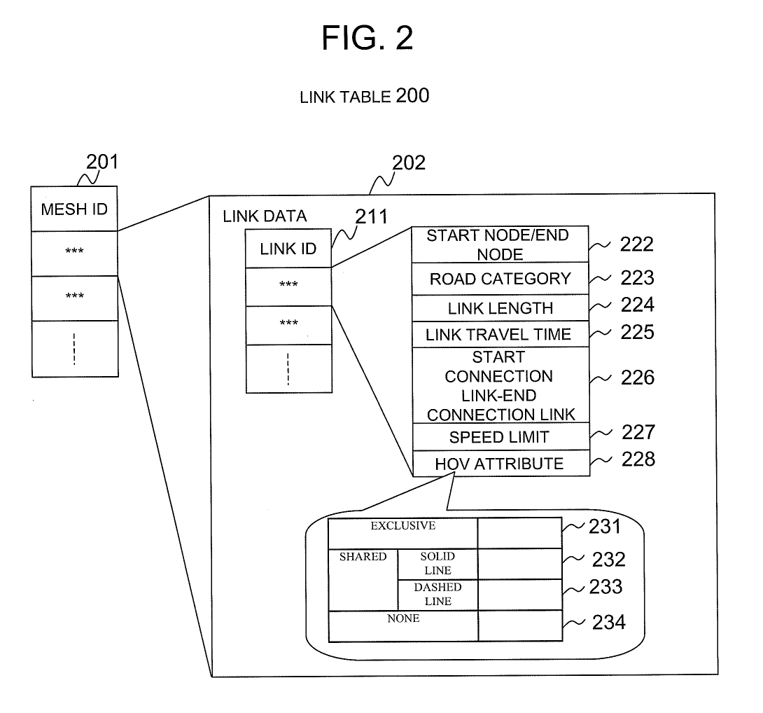

FIG. 2 is a diagram showing structure of the link table 200. For each identification code (a mesh ID) 201 of a mesh as a compartment area on a map, the link table 200 contains link data 202 for each of links constituting the roads included in the mesh area.

For each link ID 211 as an identifier of a link, the link data 202 includes: coordinate information 222 of two nodes (a start node and an end node) constituting the link; a road category 223, which indicates a category of the road including the link in question; a link length 224, which indicates the length of the link; a link travel time 225 stored previously; a start connection link-end connection link 226, which specifies a start connection link as a link connecting to the start node of the link in question and an end connection link as a link connecting to the end node of the link in question; a speed limit 227, which indicates a speed limit of the road including the link in question; an HOV attribute 228, which specifies an attribute concerning a state of setting-up of an HOV lane for the link; and the like.

As the HOV attribute 228, the link in question has a “exclusive” attribute 231 when the link consists of HOV lanes only: and a “none” attribute 234 when the link is a road that is not provided with an HOV lane. Further, when the link in question is a road having both an HOV lane and an ordinary lane and a lane change between an HOV lane and an ordinary lane is prohibited at that link, the link has a “shared-solid line” attribute 232. And, when the link in question is a road having both an HOV lane and an ordinary lane and a lane change between an HOV lane and an ordinary lane is permitted at that link, the link has a “shared-dashed line” attribute 233. Thus, it is said that the HOV attribute 228 stores information specifying a setting-up state of an HOV lane.

Here, the two nodes constituting a link are distinguished as a start node and an end node, so that the upbound direction and the downbound direction of the same road are managed as different links from each other.

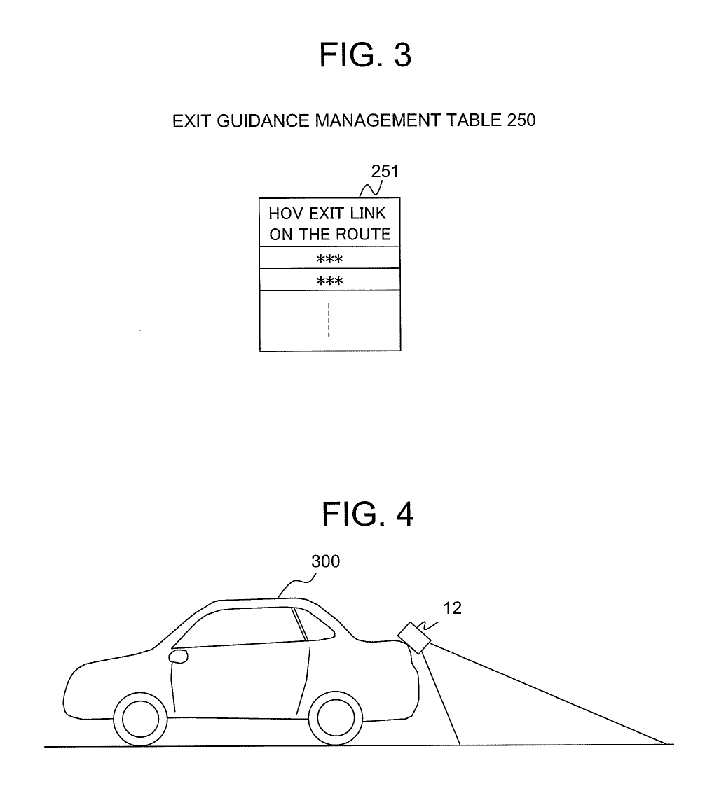

FIG. 3 is a diagram showing structure of the exit guidance management table 250. The exit guidance management table 250 contains an HOV exit link 251 on a route, which specifies an HOV exit included in a recommended route.

Description will be given returning to FIG. 1. The voice input-output unit 4 comprises the microphone 41 as a voice input unit and the speaker 42 as a voice output unit. The microphone 41 obtains sound outside the navigation device 100, such as voice coming from the user or another passenger.

The speaker 42 outputs, as voice, a message that is generated for the user by the processing part 1. The microphone 41 and the speaker 42 are placed separately at predefined positions of a vehicle. However, they may be housed in an integral case. The navigation device 100 can be provided with a plurality of microphones 41 and/or a plurality of speakers 42.

The input unit 5 is a device for receiving an instruction from the user through operation of the user. The input unit 5 comprises a touch panel 51, a dial switch 52, a scroll key as another hard switch (not shown), a scale change key, and the like. Further, the input unit 5 includes a remote control that can remotely give an operating instruction to the navigation device 100. The remote control is provided with a dial switch, a scroll key, a scale change key and the like, and can send information on operation of each key or switch to the navigation device 100.

The touch panel 51 is mounted on the display surface side of the display 2, and it is possible to see the display screen through the touch panel 51. The touch panel 51 specifies a touched position in relation to the X-Y coordinate of an image displayed on the display 2, converts the position into a coordinate, and outputs the obtained coordinate. The touch panel 51 comprises pressure-sensitive type or electrostatic type input detection elements or the like.

The dial switch 52 is constructed so as to be rotatable clockwise and counterclockwise, generates a pulse signal for each rotation of a prescribed angle, and outputs the generated pulse signals to the processing part 1. The processing part 1 obtains the angle of rotation on the basis of the number of the pulse signals.

The ROM unit 6 comprises a storage medium that is at least readable such as a Read-Only Memory (ROM) (such as a CD-ROM or a DVD-ROM) or an Integrated Circuit (IC) card. Such a storage medium stores moving image data or voice data, for example.

The vehicle speed sensor 7, the gyro sensor 8 and the GPS receiver 9 are used for the navigation device 100 to detect the current location (i.e. the location of the vehicle itself). The vehicle speed sensor 7 is a sensor that outputs a value used for calculating the vehicle speed. The gyro sensor 8 comprises an optical-fiber gyroscope, a vibrational gyroscope, or the like, and detects an angular velocity due to turning of a moving body. The GPS receiver 9 receives signals from GPS satellites and measures a distance between a moving body and each GPS satellite and a rate of change of that distance with respect to three or more satellites, in order to measure the current location, the traveling speed and a traveling direction of the moving body.

The FM multiplex broadcast receiver 10 receives an FM multiplex broadcast signal sent from an FM broadcast station. As FM multiplex broadcast, general current-state traffic information, traffic regulation information, Service Area/Parking Area (SA/PA) information, parking lot information, weather information and the like of Vehicle Information Communication System (VICS, a registered trademark) information, and text information provided as FM multiplex general information from a radio station can be received.

The beacon receiver 11 receives general current-state traffic information, traffic regulation information, Service Area/Parking Area (SA/PA) information, parking lot information, weather information, emergency information and the like of, for example, VICS information. For example, an optical beacon receiver using light-wave communication or a radio beacon receiver using radio wave can be mentioned as the beacon receiver.

FIG. 4 shows the camera 12 attached on the back of a vehicle 300. The camera 12 is slanted downward in some degree to take an image of the ground surface posterior to the vehicle, by using an image pickup device such as a Charge Coupled Device (CCD) image sensor or a Complementary Metal Oxide Semiconductor (CMOS) image sensor. Further, there is no limit to the position at which the camera 12 is attached. For example, the camera 12 can be attached on the front part of the vehicle 300 to take an image of the ground surface ahead of the vehicle.

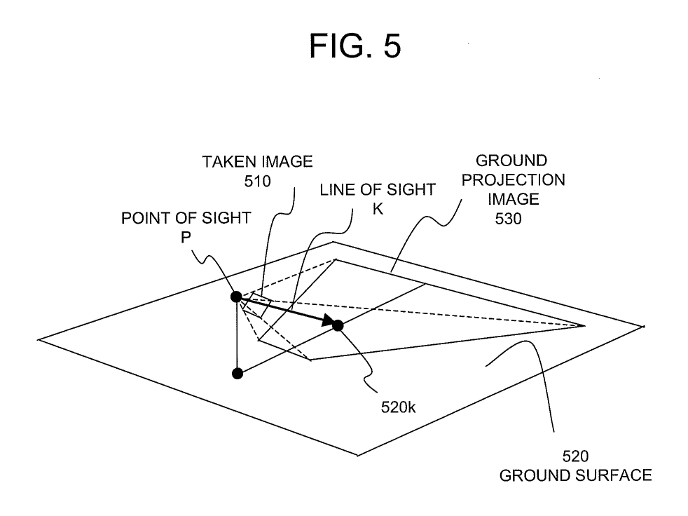

FIG. 5 is a view for explaining a method of generating a ground projection image (i.e. an image obtained by projection on the ground) by using an image taken by the camera 12 of FIG. 4. The below-mentioned camera control part 104 obtains the position (a coordinate position in a 3D space with its origin at a prescribed position in the vehicle) of the point of sight P of the camera 12 and the image-taking direction (the line of sight) K. Then, the camera control part 104 generates a ground projection image 530 by projecting the taken image 510 on the ground surface 520 in the image-taking direction K from the position of the point of sight P of the camera 12. Here, the image-taking direction K intersects the taken image 510 perpendicularly at its center. Further, the distance from the point of sight P of the camera 12 to the taken image 510 is determined previously. The thus-generated ground projection image 530 is like a bird's-eye view of an area in the neighborhood of the vehicle seen from the sky over the vehicle.

The vehicle-mounted network communication unit 13 connects the navigation device 100 with a network (not shown) supporting a vehicle control network standard such as CAN or the like, and performs communication with an Electronic Control Unit (ECU) as another vehicle control unit connected with the network, by sending and receiving CAN messages to and from the ECU.

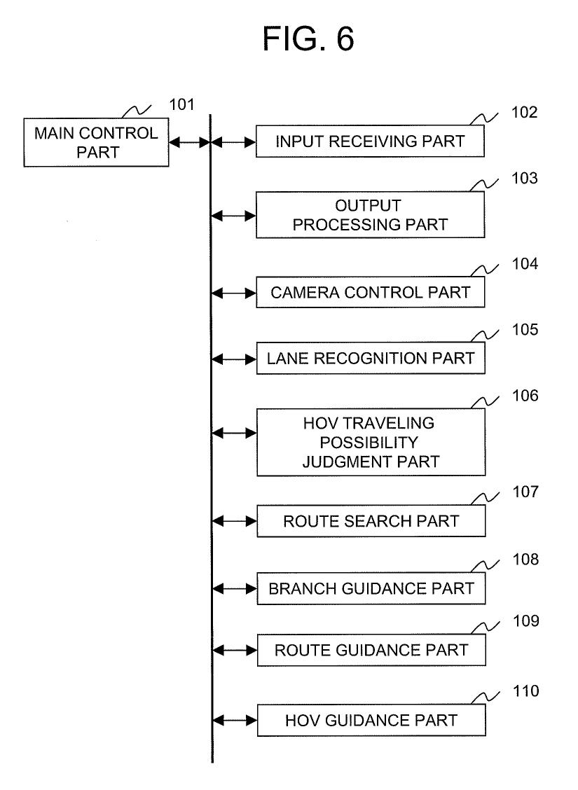

FIG. 6 is a functional block diagram showing the processing part 1. As shown in the figure, the processing part 1 comprises a main control part 101, an input receiving part 102, an output processing part 103, the camera control part 104, a lane recognition part 105, an HOV traveling possibility judgment part 106, a route search part 107, a branch guidance part 108, a route guidance part 109, and an HOV guidance part 110.

The main control part 101 is a central functional part that performs various types of processing. The main control part 101 controls other processing parts depending on a content of processing. Further, the main control part 101 obtains information from various sensors, the GPS receiver 9 and the like, and performs map matching processing and the like to identify the current location. Further, at an appropriate time, the main control part 101 associates the date and time of traveling with the location, to record in the storage unit 3 a traveling history for each link. Further, in response to a request from each processing part, the main control part 101 outputs the current time. Also, the main control part 101 manages various types of setting information held in the navigation device 100. That is to say, from the user, the main control part 101 receives information to be set as the various types of setting information, through the input receiving part 102, and stores the received information in a prescribed position of the storage unit 3. Among the various types of setting information, the main control part 101 receives information on use of an HOV lane (for example, information set as either “true” or “false” as to whether an HOV lane are to be used positively), and stores the received information in the storage unit 3. When the main control part 101 receives, from another control part, a request for providing the various types of setting information, the main control part 101 provides the various types of setting information to the control part that has sent the request.

The input receiving part 102 receives an instruction inputted from the user through the input unit 5 or the microphone 41, and controls each part of the processing part 1 so that processing corresponding to the content of the request is performed. For example, in the case where the user requests a search for a recommended route, the input receiving part 102 requests the output processing part 103 to perform processing for displaying a map for setting a destination on the display 2.

The output processing part 103 receives screen information to display (such as polygon information, for example), converts the received information into a signal so that the information can be drawn on the display 2, and instructs the display 2 to perform drawing.

The camera control part 104 controls operation of the camera 12. For example, the camera control part 104 sets timing of start and end of taking an image by the camera 12. Further, the camera control part 104 controls sending of the taken image to the lane recognition part 105.

The lane recognition part 105 obtains an image (as image data) taken by the camera 12, and converts the obtained image to an image for displaying (a ground projection image). Further, from the obtained image, the lane recognition part 105 recognizes marks and the like laid or colored on the road surface, to identify the lane in which the vehicle is traveling. For example, as described later, when the lane recognition part 105 recognizes existence of, for example, a mark (a diamond painting) indicating an HOV lane nearly at the center in the width direction of the image, then the lane recognition part 105 judges that the vehicle 300 is traveling in an HOV lane. Or, when the lane recognition part 105 recognizes the mark not nearly at the center in the width direction of the image but in a position closer to the right or left side and additionally the mark is on the edge side of the image beyond a lane mark seen from the vicinity of the center, then the lane recognition part 105 judges that the vehicle is traveling not in an HOV lane but in the lane adjacent to an HOV lane.

The HOV traveling possibility judgment part 106 judges whether the vehicle 300 is allowed to travel in an HOV lane or not. In judging the traveling possibility, the HOV traveling possibility judgment part 106 makes judgment, through the vehicle-mounted network communication unit 013, on the type and the like of the vehicle 300 on the basis of communication information flowing through the vehicle-mounted network of the vehicle 300, to judge whether the vehicle is of the type that is allowed to travel in an HOV lane. Of course, the judgment of traveling possibility is not limited to this. For example, the HOV traveling possibility judgment part 106 may identify the number of passengers by means of a load sensor (not shown) attached on each seat of the vehicle or by means of seat belt wearing sensors, to judge whether the number of passengers reaches the required number for traveling in an HOV lane.

The route search part 107 searches for the optimum route (recommended route) that connects the departure place designated by the user or the current location to the destination. In performing the route search, route search logic such as the Dijkstra's algorithm is employed to search for a route on the basis of a link cost previously set to each specific section (i.e. link) of roads. In this processing, the route search part 107 requests the HOV traveling possibility judgment part 106 to judge whether the vehicle is in a condition possible for traveling in an HOV lane. If the vehicle is in a condition possible for traveling in an HOV lane, the search for a recommended route is performed by giving priority to a route using an HOV lane. If the vehicle is not in a condition possible for traveling in an HOV lane, the route search part 107 searches for a route for which the link cost is least, without considering an HOV lane. In this processing, if the vehicle is already traveling in an HOV lane although it is judged that the vehicle is not in a condition possible for traveling in the HOV lane, the route search part 107 searches for a recommended route by giving priority to a route using the HOV lane. In judging whether the vehicle is already traveling in an HOV lane or not, the route search part 107 refers to the HOV attribute 228 of the link to which the current location belongs. If the HOV attribute 228 is “exclusive”, the route search part 107 judges that the vehicle is traveling in an HOV lane. If the HOV attribute 228 is “none”, the route search part 107 judges that the vehicle is not traveling in an HOV lane. And, if the HOV attribute 228 is “shared”, the route search part 107 makes the judgment by requesting the lane recognition part 105 to judge whether the traveling lane is an HOV lane or not.

The branch guidance part 108 guides the user about existence and location of a merging point with another road, a branch to another road or the like, by using image or voice. For example, before a merging location of a branch line with a main line of, for example, an expressway, the branch guidance part 108 outputs a display informing the user that the merging point is coming closer or informing the user of the approximate distance to the merging point, to the display 2 through the output processing part 103. Further, for example at a branch point from a main line to a ramp of an expressway, the branch guidance part 108 informs the user which lane the vehicle should travel in, by voice through the speaker 42.

The route guidance part 109 guides the user in driving operation, by using the speaker 42 and/or the display 2 so that the current location of the vehicle does not deviate from the recommended route.

The HOV guidance part 110 guides the user at an entrance or an exit of an HOV lane concerning entrance or exit between the HOV lane and an ordinary lane. In detail, at an entrance or an exit of an HOV lane (usually an entrance and an exit are not distinguished, being used for both purposes), the HOV guidance part 110 informs the user by use of voice/image or the like to the effect that the vehicle should go into the HOV lane, or that the vehicle should go out of the HOV lane, or that the vehicle should keep the traveling lane. In such guidance, as described below, when it is possible to exit from the HOV lane to an ordinary lane without deviating from the recommended route, the HOV guidance part 110 can give guidance into the HOV lane at an entrance of the previous HOV lane entrance. Thus, it is said that, when the vehicle is forced to deviate from the recommended route since it is impossible to exit from the HOV lane, the HOV guidance part 110 does not give guidance into the HOV lane at the nearest entrance/exit even if it is possible to enter into the HOV lane from that entrance/exit.

Here, the HOV guidance part 110 gives guidance, at an exit section from the HOV lane, to the effect that the vehicle should exit from the HOV lane, and, at an entrance section into the HOV lane, to the effect that the vehicle should enter into the HOV lane. Further, as the exit section from the HOV lane, the HOV guidance part 110 specifies a section closer to the destination among the sections (on the recommended route) that allow exit from the HOV lane. This is for traveling in the HOV lane as far as possible.

Further, if there is not a section allowing entering into the HOV lane before the exit section on the recommended route, the HOV guidance part 110 perform neither guidance for exiting nor guidance for entering.

Further, when the HOV guidance part 110 detects vehicle's entry into the HOV lane after the guidance for entering and detects vehicle's exit from the HOV lane before arriving at the exit section, the HOV guidance part 110 stops guidance for exiting. When the guidance for exiting is stopped, the HOV guidance part 110 specifies once again an exit section from the HOV lane on the recommended route, and performs guidance for exiting and guidance for entering.

The above-described functional parts of the processing part 1, namely, the main control part 101, the input receiving part 102, the output processing part 103, the camera control part 104, the lane recognition part 105, the HOV traveling possibility judgment part 106, the route search part 107, the branch guidance part 108, the route guidance part 109, and the HOV guidance part 110 are each realized when the CPU 21 reads and executes a prescribed program. To that end, the RAM 22 stores the program for realizing processing of each functional part.

The above-described components are results of component classification of the navigation device 100 according to main contents of processing, in order to make it easy to understand the configuration of the navigation device 100. Thus, the way of classification of components and their names do not restrict the present invention. The components of the navigation device 100 can be classified into a larger number of components according to contents of processing. Or, it is possible to classify components such that each component performs more contents of processing.

Further, each functional part may be realized by hardware (such as ASIC or GPU). Further, processing of each functional part may be performed by one hardware unit or by a plurality of hardware units.

### [Description of Operation]

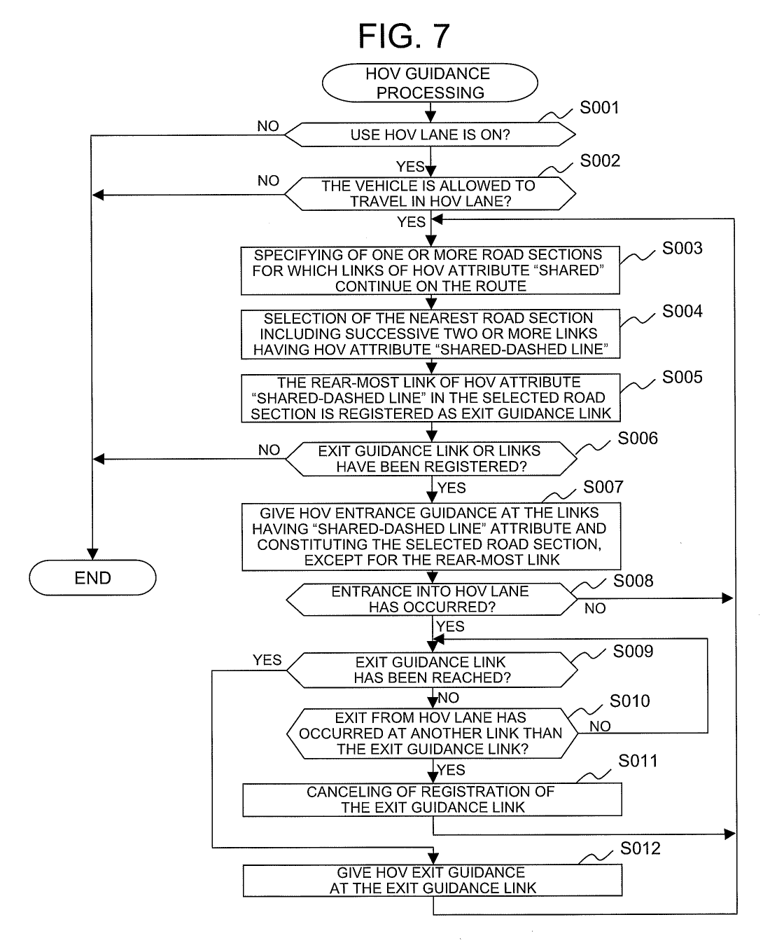

Next, operation of HOV guidance processing performed by the navigation device 100 will be described. FIG. 7 is a flowchart showing the HOV guidance processing performed by the navigation device 100. This flow is started when the navigation device 100 is powered on to be activated.

First, the HOV guidance part 110 judges whether the navigation device 100 is set to use an HOV lane or not (Step S001). In detail, the HOV guidance part 110 obtains, from the main control part 101, information on use of an HOV lane (for example, information set as either “true” or “false” as to whether an HOV lane is to be used) among the various types of setting information. And, by referring to the obtained information, the HOV guidance part 110 judges whether the navigation device 100 is set to use an HOV lane.

If the navigation device 100 is set to use an HOV lane (“Yes” in Step S001), the HOV guidance part 110 judges whether the vehicle is allowed to travel in an HOV lane or not (Step S002). In detail, the HOV guidance part 110 requests the HOV traveling possibility judgment part 106 to judge whether the vehicle is allowed to travel in an HOV lane.

If it the navigation device 100 is not set to use an HOV lane (“No” in Step S001), or if the vehicle is not allowed to travel in an HOV lane (“No” in Step S002), the HOV guidance part 110 ends the HOV guidance processing.

If the vehicle is allowed to travel in an HOV lane (“Yes” in Step S002), the HOV guidance part 110 specifies one or more road sections for which links of the HOV attribute “shared” continue on the recommended route (Step S003). In detail, the HOV guidance part 110 obtains information on the recommended route from the main control part 101, reads the HOV attribute 228 of each link included in the recommended route from the link table 200, and specifies links whose HOV attributes 228 are “shared-dashed line” 233. Then, if the links are successive links, the HOV guidance part 110 brings them together to specify then as one road section.

Next, the HOV guidance part 110 selects the road section closest to the vehicle among road sections each including links of the HOV attribute of “shared-dashed line” 233 (the road sections specified in Step S003) (Step S004).

Next, as for the road section selected in Step S004, the HOV guidance part 110 registers, as an exit guidance link, the rear-most link having the HOV attribute “shared-dashed line” into the HOV exit link 251 of the exit guidance management table 250 (Step S005).

Next, the HOV guidance part 110 judges whether one or more exit guidance links have been registered in Step S005 (Step S006). If no exit guidance link has been registered (“No” in Step S006), the HOV guidance part 110 ends the HOV guidance processing.

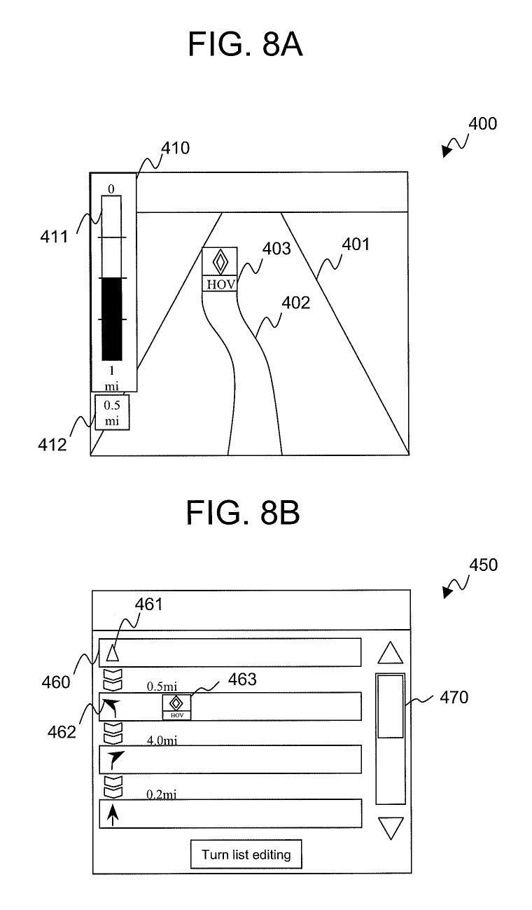

If one or more exit guidance links have been registered (“Yes” in Step S006), the HOV guidance part 110 performs HOV entrance guidance at the other links than the rear-most link in the links that constitute the selected road section and have the “shared-dashed line” attribute (Step S007). In detail, the HOV guidance part 110 uses the screen 400 or the screen 450 shown in FIGS. 8A and 8B, to guide the user to enter the HOV lane. That is to say, in the case where there are a plurality of links as the other links than the rear-most link among the links that constitute the selected road section and have the “shared-dashed line” attribute, the HOV guidance part 110 provides guidance for entrance into the HOV lane for the link which approaches the link concerned first and then the guidance will be given successively to the other links approaching the link subsequently.

FIGS. 8A and 8B are views for explaining a screen outputted by the HOV guidance part 110. FIG. 8A is an example of a screen of the HOV entrance guidance by the HOV guidance part 110 in the route guidance processing. FIG. 8B is an example of a screen of the HOV entrance guidance by the HOV guidance part 110 in route displaying. The screen 400 shown in FIG. 8A comprises: a forward road figure 401 showing a forward road; a traveling lane display figure 402 showing a traveling lane; an HOV lane figure 403 showing forward existence of an HOV lane; a distance display figure 410 displaying the distance to the point of entering into the HOV lane; a distance meter 411 displayed being superimposed on the distance display figure 410; and a distance display 412 showing numerically the distance to the point of entering into the HOV lane. The distance meter 411 and the distance display 412 show the distance to the point of entering into the HOV lane, and thus the user can grasp timing for driving operation for entering into the HOV lane. Further, the HOV lane figure 403 is displayed at the position indicating the forward direction of the traveling lane display figure 402, and thus the user can grasp that he should enter into the HOV lane, and grasp the traveling lane at the time of entering.

The screen 450 shown in FIG. 8B comprises: checkpoint figures 460 showing prescribed checkpoints (for example, an intersection at which left turn or right turn is carried out on the route); a vehicle location figure 461 displayed being superimposed on a checkpoint figure 460; a right-left turn figure 462 displayed being superimposed on a checkpoint figure 460; an HOV lane figure 463 displayed being superimposed on a checkpoint figure 460; and a scrolling operation figure 470 for receiving an instruction of screen scrolling. By the checkpoint figures 460, the user can grasp information on, for example, an intersection to take a right or left turn on the recommended route. That is to say, by seeing the HOV lane figure 463 superimposed on checkpoint figures arranged in the traveling order, the user can quickly grasp at which checkpoint he should enter into the HOV lane.

Next, the HOV guidance part 110 judges whether the vehicle on which the navigation device 100 is mounted has entered into an HOV lane or not (Step S008). In detail, the HOV guidance part 110 requests the lane recognition part 105 to judge whether the lane in which the vehicle mounted with the navigation device 100 is traveling is an HOV lane or not. As described above, the lane recognition part 105 judges whether the vehicle is traveling in an HOV lane or not, on the basis of a taken image of the backward or forward area of the vehicle, and notifies the HOV guidance part 110 of the result.

If the vehicle has not entered into an HOV lane (“No” in Step S008), the HOV guidance part 110 returns the processing to Step S003. If the vehicle has entered into an HOV lane (“Yes” in Step S008), the HOV guidance part 110 judges whether the vehicle has reached the exit guidance link while keeping traveling in the HOV lane (Step S009). If the vehicle has not arrived at the exit guidance link (“No” in Step S009), the HOV guidance part 110 judges whether the vehicle has exited from the HOV lane through another link than the exit guidance link (Step S010). In detail, the HOV guidance part 110 requests the lane recognition part 105 to identify, as the location where the vehicle has exited, an HOV link that has the “shared-dashed line” attribute and is in the neighborhood of the location at which the traveling lane of the vehicle mounted with the navigation device 100 has become a non-HOV lane. If it is impossible to identify such a location, then the HOV guidance part 110 judges that the vehicle has not exited from the HOV lane.

If the vehicle has exited from the HOV lane (“Yes” in Step S010), the HOV guidance part 110 cancels the registration of the exit guidance link (Step S011), and thereafter returns the processing to Step S003.

If the vehicle has not exited from the HOV lane (“NO” in Step S010), the HOV guidance part 110 returns the processing to Step S009, to detect arrival at the exit guidance link and exit from the HOV lane.

If the vehicle has arrived at the exit guidance link while keeping traveling in the HOV lane (“Yes” in Step S009), the HOV guidance part 110 performs the HOV exit guidance at the registered exit guidance link (Step S012). Then, the HOV guidance part 110 returns the processing to Step S003.

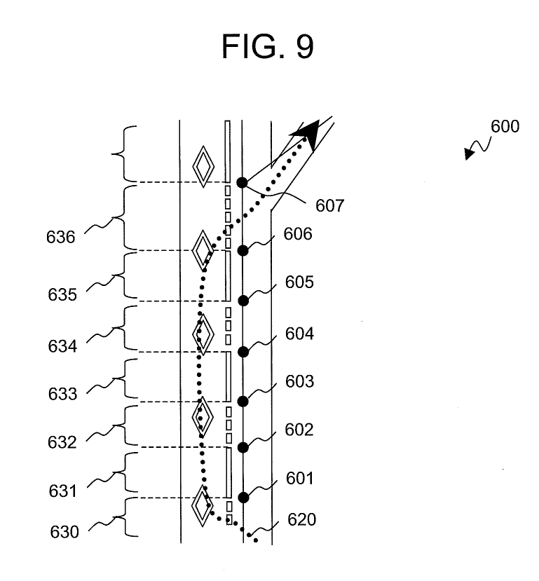

FIG. 9 is a view illustrating an example of traveling of a vehicle in a road 600 shared by an HOV lane and an ordinary lane. The road 600 includes nodes 601-607. A part 630 before the node 601 is a link having the “shared-dashed line” attribute, i.e. the attribute of an entrance/exit of an HOV lane. Further, a part 632 between the nodes 602 and 603, a part 634 between the nodes 604 and 605, and a part 636 between the nodes 606 and 607 are each a link having the “shared-dashed line” attribute, i.e. the attribute of an entrance/exit of an HOV lane.

Further, a part 631 between the nodes 601 and 602, a part between 633 the nodes 603 and 604, and a part 635 between the nodes 605 and 606 are each a link having the “shared-solid line” attribute, i.e. the attribute of non-entrance/exit of an HOV lane.

Further, beyond the node 607, the road divides into two roads, i.e. a road 637 for traveling in a straight line without change and a road exiting from the road 637. Here, it is assumed that the recommended route 620 shows a route that includes entering into the HOV lane through the part 630 before the node 601, traveling in the HOV lane, exiting from the HOV lane at the part 636 between the nodes 606 and 607, and traveling in the road that exits from the road after the node 607.

In the situation of FIG. 9, the HOV guidance part 110 performs the HOV entrance guidance at the roads 630, 632 and 634, and performs the HOV exit guidance at the road 636.

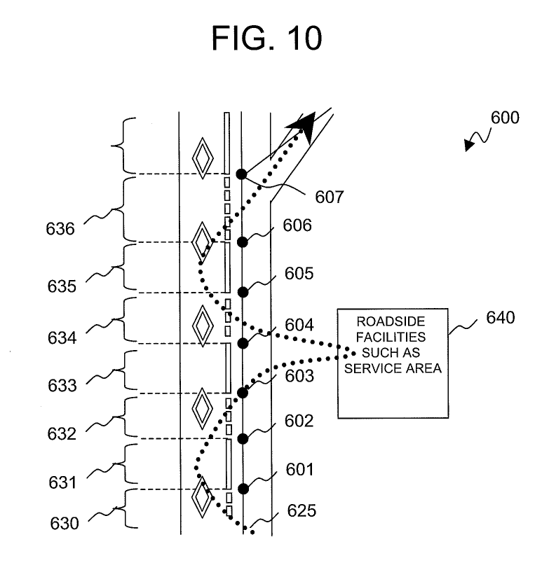

FIG. 10 is a view illustrating a route 625 in the case where a vehicle drops in a roadside facilities 640 such as a service area in a situation similar to that shown in FIG. 9. That is to say, the vehicle 625 travels along a route that includes entering into an HOV lane under the HOV entrance guidance in a road 630, exiting from the HOV lane in a road 632 to drop in the roadside facilities 640 such as a service area, thereafter entering the HOV lane under the HOV entrance guidance in a road 634, and exiting from the HOV lane under the HOV exit guidance in a road 636. Also in this case, according to the above-described HOV guidance processing, the HOV guidance part 110 can perform the HOV entrance guidance in the roads 630 and 634, and perform the HOV exit guidance in the road 636.

Hereinabove, the content of the HOV guidance processing has been described. By performing the above-described HOV guidance processing, the navigation device 100 can inform the user, in an easy-to-understand manner, of entrances and exits to use for traveling along the recommended route. Further, also as for a vehicle that has exited from an HOV lane to drop in a roadside facilities, the navigation device 100 can suitably perform the entrance guidance to the HOV lane again and the exit guidance from the HOV lane. Further, the entrance guidance is performed after specifying an exit in the case of traveling in a recommended route, and thus it is possible to avoid the HOV entrance guidance that results in deviation from the recommended route due to impossibility of exit from an HOV lane. Thus, the user can appropriately travel in the recommended route by following instructions of the navigation device without anxiety.

The above-described processing assumes traveling in an HOV lane of an ordinary road, but the invention is not limited to this. For example, it is possible to perform guidance suitably for HOV entrance/exit also for a route including an expressway or the like. That is to say, in the case where there is entry/exit to/from an expressway or the like, it is possible to perform search by separating sections using an HOV lane into an expressway section and an ordinary road section, to make entry and exit to and from the HOV lane complete within each of the expressway section and the ordinary road section. By doing so, it is possible, also in a recommended route including an expressway, to perform guidance for an entrance/exit of an HOV lane in a suitable manner.

Hereinabove, an embodiment relating to the first point of the invention has been described. According to the above-described embodiment relating to the first point of the invention, the navigation device 100 can inform the user of an entrance/exit to use for traveling along a recommended route in an easy-to-understand manner.

The present invention is not limited to the above-described embodiment relating to the first point of the invention. The above-described embodiment relating to the first point of the invention can be varied variously within the spirit and scope of the invention. For example, as for the lane recognition processing by the lane recognition part 105, the lane recognition may be performed on the basis of high-precision location information of GPS or information received from oscillators laid on each lane for lane recognition.

Next, a navigation device to which an embodiment relating to the second point of the invention is applied will be described referring to drawings.

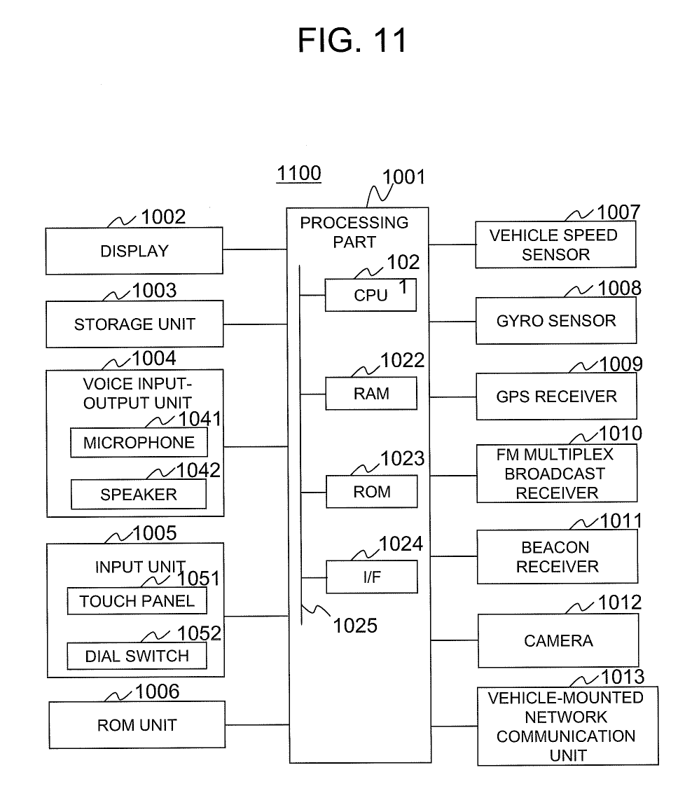

FIG. 11 is a diagram showing a general configuration of a navigation device 1100. As a so-called navigation device, the navigation device 1100 can display map information to indicate a point denoting the current location of the navigation device 1100 and information for guidance along a route to an already-set destination.

The navigation device 1100 comprises a processing part 1001, a display 1002, a storage unit 1003, a voice input-output unit 1004 (having a microphone 1041 as a voice input unit and a speaker 1042 as a voice output unit), an input unit 1005, a ROM unit 1006, a vehicle speed sensor 1007, a gyro sensor 1008, a Global Positioning System (GPS) receiver 1009, an FM multiplex broadcast receiver 1010, a beacon receiver 1011, a camera 1012, and a vehicle-mounted network communication unit 1013.

The processing part 1001 is a central unit that performs various types of processing. For example, the processing part 1001 calculates a current location on the basis of information outputted from the various types of sensors 1007, 1008, the GPS receiver 1009, the FM multiplex broadcast receiver 1010 and the like. Further, based on the obtained current location information, the processing part 1001 reads out map data required for display from the storage unit 1003 or the ROM unit 1006.

Further, the processing part 1001 expands the read map data into graphics, superimposes a mark denoting the current location on the graphics, and displays the result on the display 1002. Further, by using map data and the like stored in the storage unit 1003 or the ROM unit 1006, the processing part 1001 searches for the optimum route (recommended route) connecting a departure place designated by the user or the current location to a destination (or a way point or a stopover point). Further, the processing part 1001 guides the user by using the speaker 1042 and/or the display 1002.

Further, as described below, in performing the route search, the processing part 1001 can give priority to a route using an HOV lane. An HOV lane is a lane for which it is prescribed that only a vehicle carrying at least a prescribed number of passengers (for example, two including a driver) or a vehicle satisfying specific criteria (such as fuel efficiency standards or low-pollution criteria) can travel in it. At that time, the processing part 1001 judges whether the vehicle can actually travel along the route obtained by the route search. If it is impossible to travel along the route, the processing part 1001 searches again by changing the search criteria, to obtain a route along which the vehicle can travel.

The processing part 1001 of the navigation device 1100 is constructed by connecting component devices through a bus 1025. The processing part 1001 comprises: a Central Processing Unit (CPU) 1021, which executes various types of processing such as numerical operation and control of each component device; a Random Access Memory (RAM) 1022 for storing map data, operation data and the like read from the storage unit 1003; a Read Only Memory (ROM) 1023 for storing programs and data; and an interface (I/F) 1024 for connecting various hardware units with the processing part 1001.

The display 1002 is a unit for displaying graphics information generated by the processing part 1001 or the like. The display 1002 comprises a liquid crystal display, an organic EL display, or the like.

The storage unit 1003 comprises a storage medium that is at least readable-writable, such as a Hard Disk Drive (HDD), a nonvolatile memory card, or the like.

This storage medium stores a link table 1200, i.e. map data (including link data concerning links as components of each road on a map) required for an ordinary route search device.

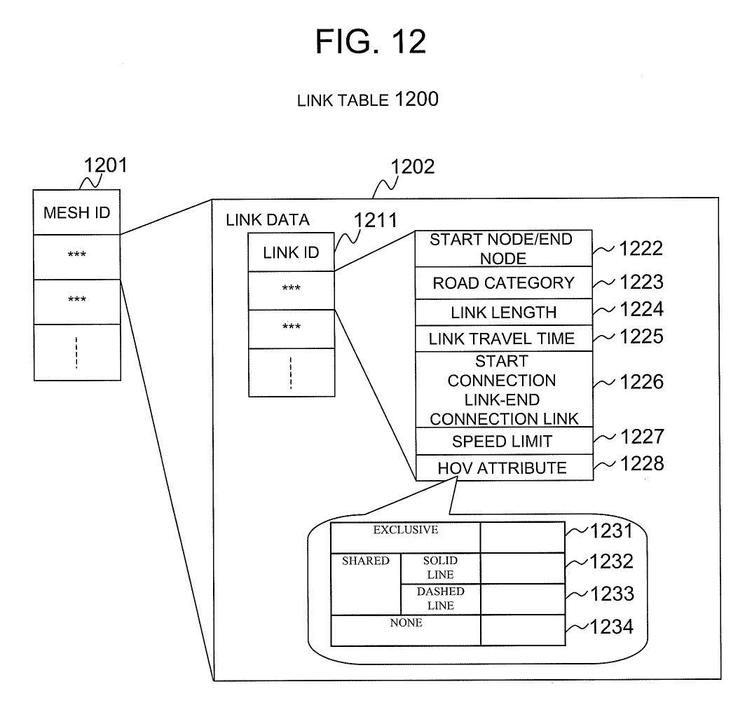

FIG. 12 is a diagram showing structure of the link table 1200. For each identification code (a mesh ID) 1201 of a mesh as a compartment area on a map, the link table 1200 contains link data 1202 for each of links constituting the roads included in the mesh area.

For each link ID 1211 as an identifier of a link, the link data 1202 includes: coordinate information 1222 of two nodes (a start node and an end node) constituting the link; a road category 1223, which indicates a category of the road including the link in question; a link length 1224, which indicates the length of the link; a link travel time 1225 stored previously; a start connection link-end connection link 1226, which specifies a start connection link as a link connecting to the start node of the link in question and an end connection link as a link connecting to the end node of the link in question; a speed limit 1227, which indicates a speed limit of the road including the link in question; an HOV attribute 1228, which specifies an attribute concerning a state of setting-up of an HOV lane for the link; and the like.

As the HOV attribute 1228, the link in question has a “exclusive” attribute 1231 when the link consists of HOV lanes only: and a “none” attribute 1234 when the link is not provided with an HOV lane. Further, when the link in question has both HOV lane and ordinary lane and a lane change is prohibited in the road at that link, the link has a “shared-solid line” attribute 1232. And, when the link in question has both HOV lane and ordinary lane and a lane change is permitted, the link has a “shared-dashed line” attribute 1233. Thus, it is said that the HOV attribute 1228 stores information specifying a setting-up state of an HOV lane.

Here, the two nodes constituting a link are distinguished as a start node and an end node, so that the upbound direction and the downbound direction of the same road are managed as different links respectively.

Description will be give returning to FIG. 11. The voice input-output unit 1004 comprises the microphone 1041 as a voice input unit and the speaker 1042 as a voice output unit. The microphone 1041 obtains sound outside the navigation device 1100, such as voice coming from the user or another passenger.

The speaker 1042 outputs, as voice, a message that is generated for the user by the processing part 1001. The microphone 1041 and the speaker 1042 are placed separately at predefined positions of a vehicle. However, they may be housed in an integral case. The navigation device 1100 can be provided with a plurality of microphones 1041 and/or a plurality of speakers 1042.

The input unit 1005 is a device for receiving an instruction from the user through operation of the user. The input unit 1005 comprises a touch panel 1051, a dial switch 1052, a scroll key as another hard switch (not shown), a scale change key, and the like. Further, the input unit 1005 includes a remote control that can remotely give an operating instruction to the navigation device 1100. The remote control is provided with a dial switch, a scroll key, a scale change key and the like, and can send information of operation of each key or switch to the navigation device 1100.

The touch panel 1051 is mounted on the display surface side of the display 1002, and it is possible to see the display screen through the touch panel 1051. The touch panel 1051 specifies a touched position in relation to the X-Y coordinate of an image displayed on the display 1002, converts the position into a coordinate, and outputs the obtained coordinate. The touch panel 1051 comprises pressure-sensitive type or electrostatic type input detection elements or the like.

The dial switch 1052 is constructed so as to be rotatable clockwise and counterclockwise, generates a pulse signal for each rotation of a prescribed angle, and outputs the generated pulse signals to the processing part 1001. The processing part 1001 obtains the angle of rotation on the basis of the number of the pulse signals.

The ROM unit 1006 comprises a storage medium that is at least readable such as a Read-Only Memory (ROM) (such as a CD-ROM or a DVD-ROM) or an Integrated Circuit (IC) card. Such a storage medium stores moving image data or voice data, for example.

The vehicle speed sensor 1007, the gyro sensor 1008 and the GPS receiver 1009 are used for the navigation device 1100 to detect the current location (i.e. the location of the vehicle itself). The vehicle speed sensor 1007 is a sensor that outputs a value used for calculating the vehicle speed. The gyro sensor 1008 comprises an optical-fiber gyroscope, a vibrational gyroscope, or the like, and detects an angular velocity due to turning of a moving body. The GPS receiver 1009 receives signals from GPS satellites and measures a distance between a moving body and each GPS satellite and a rate of change of that distance with respect to three or more satellites, in order to measure the current location, the traveling speed and a traveling direction of the moving body.

The FM multiplex broadcast receiver 1010 receives an FM multiplex broadcast signal sent from an FM multiplex broadcast station. As FM multiplex broadcast, general current-state traffic information, traffic regulation information, Service Area/Parking Area (SA/PA) information, parking lot information, weather information and the like of Vehicle Information Communication System (VICS, a registered trademark) information, and text information provided as FM multiplex general information from a radio station can be received.

The beacon receiver 11 receives general current-state traffic information, traffic regulation information, Service Area/Parking Area (SA/PA) information, parking lot information, weather information, emergency information and the like of, for example, VICS information. For example, an optical beacon receiver using light-wave communication and a radio beacon receiver using radio wave can be mentioned as the beacon receiver.

FIG. 14 shows the camera 1012 attached on the back of a vehicle 1300. The camera 1012 is slanted downward in some degree to take an image of the ground surface posterior to the vehicle, by using an image pickup device such as a Charge Coupled Device (CCD) image sensor or a Complementary Metal Oxide Semiconductor (CMOS) image sensor. Further, there is no limit to the position at which the camera 1012 is attached. For example, the camera 1012 can be attached on the front part of the vehicle 1300 to take an image of the ground surface ahead of the vehicle.

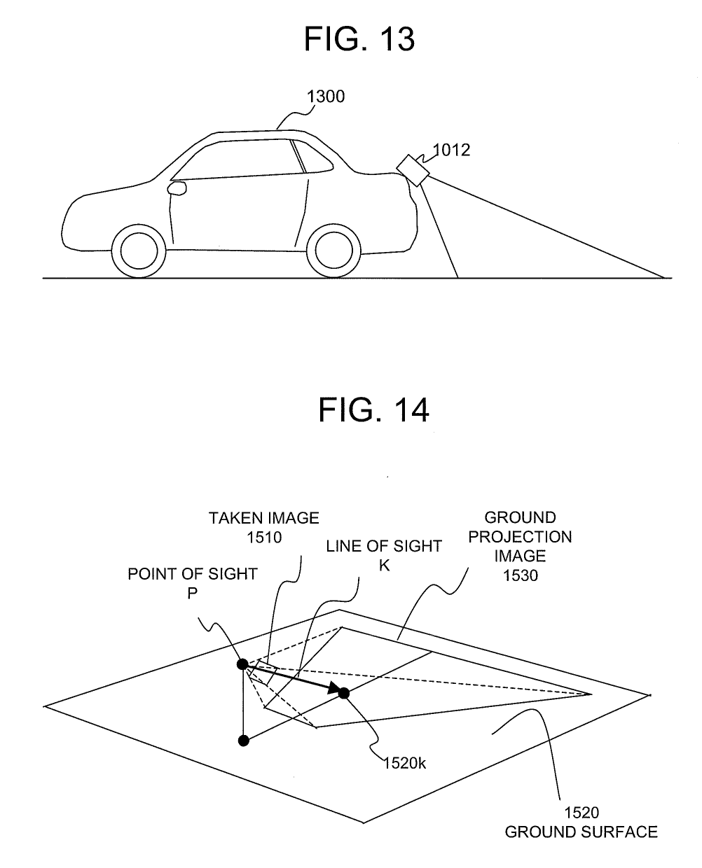

FIG. 14 is a view for explaining a method of generating a ground projection image (i.e. an image obtained by projection on the ground) by using an image taken by the camera 1012 of FIG. 13. The below-mentioned camera control part 1104 obtains the position (a coordinate position in a 3D space with its origin at a prescribed position in the vehicle) of the point of sight P of the camera 1012 and the image-taking direction (i.e. the line of sight) K. Then, the camera control part 1104 generates a ground projection image 1530 by projecting the taken image 1510 on the ground surface 1520 in the image-taking direction K from the position of the point of sight P of the camera 1012. Here, the image-taking direction K intersects the taken image 1510 perpendicularly at its center. Further, the distance from the point of sight P of the camera 1012 to the taken image 1510 is determined previously. The thus-generated ground projection image 1530 is like a bird's-eye view of an area in the neighborhood of the vehicle seen from the sky over the vehicle.

The vehicle-mounted network communication unit 1013 connects the navigation device 1100 with a network (not shown) supporting a vehicle control network standard such as CAN or the like, and sends and receives CAN messages to communicate with an Electronic Control Unit (ECU) as another vehicle control unit connected with the network.

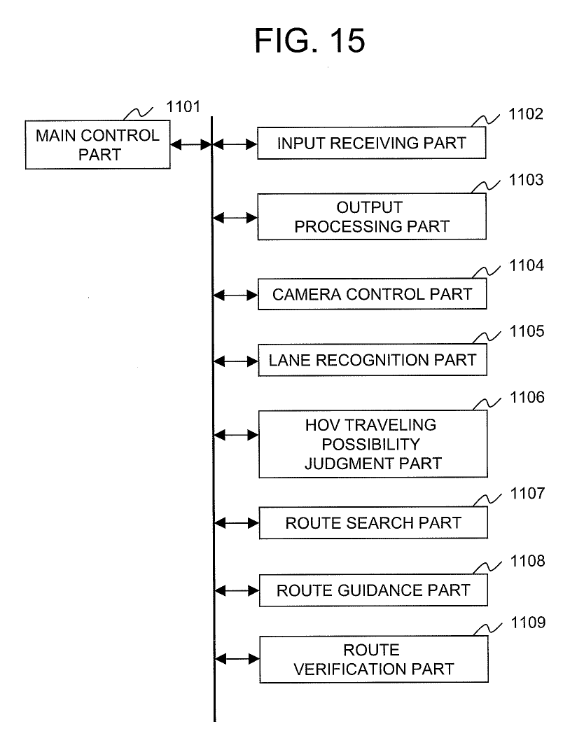

FIG. 15 is a functional block diagram showing the processing part 1001. As shown in the figure, the processing part 1001 comprises a main control part 1101, an input receiving part 1102, an output processing part 1103, the camera control part 1104, a lane recognition part 1105, an HOV traveling possibility judgment part 1106, a route search part 1107, a location guidance part 1108, a route guidance part 1108, and a route verification part 1109.

The main control part 1101 is a central functional part that performs various types of processing. The main control part 1101 controls other processing parts depending on a content of processing. Further, the main control part 1101 obtains information from various sensors, the GPS receiver 1009 and the like, and performs map matching processing and the like to identify the current location. Further, at an appropriate time, the main control part 1101 associates the date and time of traveling with the location, to record in the storage unit 1003 a traveling history for each link. Further, in response to a request from each processing part, the main control part 1101 outputs the current time. Also, the main control part 1101 manages various types of setting information held in the navigation device 1100. That is to say, from the user, the main control part 1101 receives information to be set as the various types of setting information, through the input receiving part 1102, and stores the received information in a prescribed position of the storage unit 1003. Among the various types of setting information, the main control part 1101 receives information on use of an HOV lane (for example, information set as either “true” or “false” as to whether an HOV lane are to be used positively), and stores the received information in the storage unit 1003. When the main control part 1101 receives, from another control part, a request for providing the various types of setting information, the main control part 1101 provides the various types of setting information to the control part that has sent the request.

The input receiving part 1102 receives an instruction inputted from the user through the input unit 1005 or the microphone 1041, and controls each part of the processing part 1001 so that processing corresponding to the content of the request is performed. For example, in the case where the user requests display of a map, the input receiving part 1102 requests the output processing part 1103 to perform processing for displaying a map of a prescribed range on the display 1002.

The output processing part 1103 receives screen information to display (such as polygon information, for example), converts the received information into a signal so that the information can be drawn on the display 1002, and instructs the display 1002 to perform drawing.

The camera control part 1104 controls operation of the camera 1012. For example, the camera control part 1104 sets timing of start and end of taking an image by the camera 1012. Further, the camera control part 1104 controls sending of the taken image to the lane recognition part 1105.

The lane recognition part 1105 obtains an image (as image data) taken by the camera 1012, and converts the obtained image to an image for displaying (a ground projection image). Further, from the obtained image, the lane recognition part 1105 recognizes marks and the like laid or colored on the road surface, to identify the lane in which the vehicle is traveling. For example, as described later, when the lane recognition part 1105 recognizes existence of, for example, a mark (a diamond painting) indicating an HOV lane nearly at the center in the width direction of the image, then the lane recognition part 1105 judges that the vehicle 1300 is traveling in an HOV lane. Or, when the lane recognition part 1105 recognizes the mark not nearly at the center in the width direction of the image but in a position closer to the right or left side and additionally the mark is on the edge side of the image beyond a lane mark seen from the vicinity of the center, then the lane recognition part 1105 judges that the vehicle is traveling not in an HOV lane but in the lane adjacent to an HOV lane.

The HOV traveling possibility judgment part 1106 judges whether the vehicle 1300 is allowed to travel in an HOV lane or not. In judging the traveling possibility, the HOV traveling possibility judgment part 1106 makes judgment on the type and the like of the vehicle 1300 on the basis of communication information flowing through the vehicle-mounted network of the vehicle 1300 through the vehicle-mounted network communication unit 1013, to judge whether the vehicle is of the type that is allowed to travel in the HOV lane. Of course, the judgment of traveling possibility is not limited to this. For example, the HOV traveling possibility judgment part 1106 may identify the number of passengers by means of a load sensor (not shown) attached on each seat of the vehicle or by means of seat belt wearing sensors, to judge whether the number of passengers reaches the required number for traveling in an HOV lane.

The route search part 1107 searches for the optimum route (recommended route) that connects the departure place designated by the user or the current location to the destination. In performing the route search, route search logic such as the Dijkstra's algorithm is employed to search for a route on the basis of a link cost previously set to each specific section (i.e. link) of roads. This processing is performed on the basis of the above judgment by the HOV traveling possibility judgment part 1106 on whether the vehicle is in a condition possible for traveling in an HOV lane. If it is allowed to travel in an HOV lane, the search for a recommended route is performed by giving priority to a route using an HOV lane. If the vehicle is not in a condition possible for traveling in an HOV lane, the route search part 1107 searches for a route for which the link cost is least, without considering an HOV lane. In this processing, if the vehicle is already traveling in an HOV lane although the HOV traveling possibility judgment part 1106 has judged that the vehicle is not in a condition possible for traveling in an HOV lane, the route search part 1107 searches for a recommended route by giving priority to a route using an HOV lane. In judging whether the vehicle is already traveling in an HOV lane or not, the route search part 1107 refers to the HOV attribute 1228 of the link to which the current location belongs. If the HOV attribute 1228 is “exclusive”, the route search part 1107 judges that the vehicle is traveling in an HOV lane. If the HOV attribute 1228 is “none”, the route search part 1107 judges that the vehicle is not traveling in an HOV lane. And, if the HOV attribute 1228 is “shared”, the route search part 1107 makes the judgment by requesting the lane recognition part 1105 to judge whether the traveling lane is an HOV lane or not.

The route guidance part 1108 guides the user in his driving operation, by using the speaker 1042 and the display 1002 so that the current location of the vehicle does not deviate from the recommended route.

The route verification part searches the recommended route for a location (lane change prohibition section) where the recommended route crosses over a lane change prohibition part of an HOV lane. If there is such a location, a search for a recommended route is performed again to avoid traveling of such location. That is to say, the route verification part 1109 judges whether the recommended route necessitates traveling by exiting from the HOV lane at a part where lane change between the HOV lane and the ordinary lane is not allowed (for example, at a location other than an exit from the HOV lane). If the recommended route necessitates such traveling, re-search is performed by changing the search conditions, to set a more appropriate route.

The above-described functional parts of the processing part 1001, namely, the main control part 1101, the input receiving part 1102, the output processing part 1103, the camera control part 1104, the lane recognition part 1105, the HOV traveling possibility judgment part 1106, the route search part 1107, the route guidance part 1108, and the route verification part 1109, are each realized when the CPU 1021 reads and executes a prescribed program. To that end, the RAM 1022 stores the program for realizing processing of each functional part.

The above-described components are results of component classification of the navigation device 1100 according to main contents of processing, in order to make it easy to understand the configuration of the navigation device 1100. Thus, the way of classification of components and their names do not restrict the present invention. The components of the navigation device 1100 can be classified into a larger number of components according to contents of processing. Or, it is possible to classify components such that each component performs more contents of processing.

Further, each functional part may be realized by hardware (such as ASIC or GPU). Further, processing of each functional part may be performed by one hardware unit or by a plurality of hardware units.

### [Description of Operation]

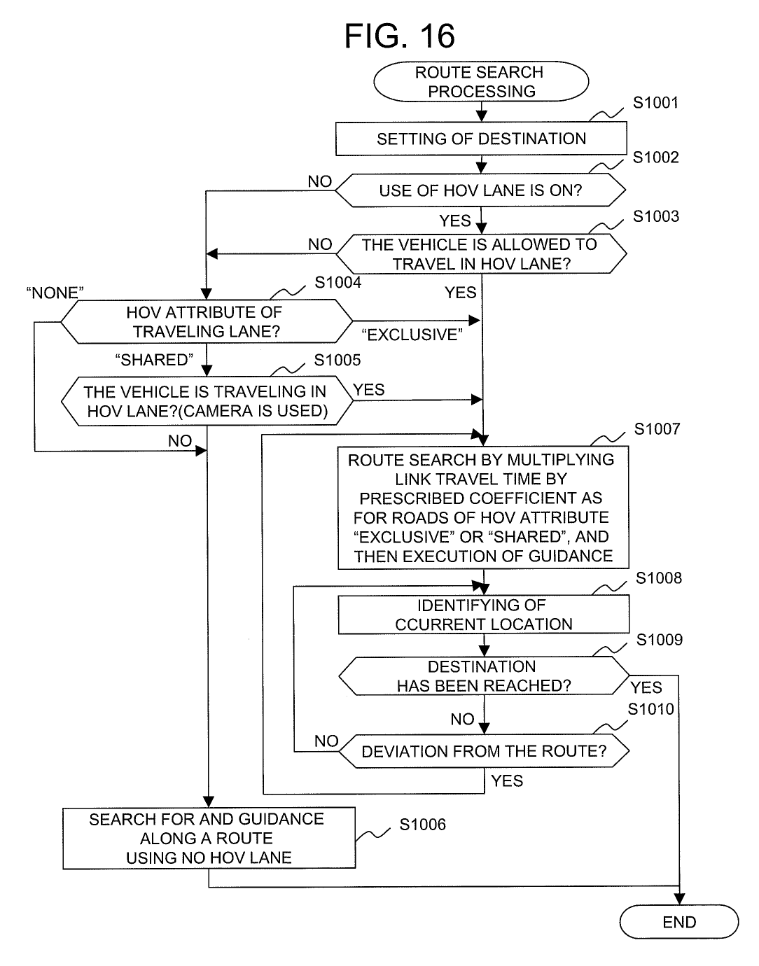

Next, operation of route search processing performed by the navigation device 1100 will be described. FIG. 16 is a flowchart showing the route search processing performed by the navigation device 1100. This flow is started when an instruction to perform a search for a recommended route is received in a state that the navigation device 1100 is operating.

First, the main control part 1101 sets a destination (Step S1001). In detail, the main control part 1101 receives input of a destination from the user through the input receiving part 1102. Then, the main control part 1101 sets the received destination as a destination of route search.

Next, the route search part 1107 judges whether the navigation device 1100 is set to use an HOV lane or not (Step S1002). In detail, among the various type of setting information held by the navigation device 1100, the route search part 1107 obtains information on use of an HOV lane (for example, information set as either “true” or “false” as to whether an HOV lane are to be used) from the main control part 1101. Then, by referring to the obtained information, the route search part 1107 judges whether the navigation device 1100 is set to use an HOV lane or not.

If the navigation device 1100 is set to use an HOV lane (“Yes” in Step S1002), the route search part 1107 judges whether the vehicle is allowed to travel in an HOV lane or not (Step S1003). In detail, the route search part 1107 requests the HOV traveling possibility judgment part 1106 to judge whether the vehicle is allowed to travel in an HOV lane.

If the navigation device 1100 is not set to use an HOV lane (“No” in Step S1002), or if the vehicle is not allowed to travel in an HOV lane (“No” in Step S1003), the route search part 1107 obtains the HOV attribute 1228 of the lane in which the vehicle is traveling, to judge whether the vehicle is traveling in an HOV lane or not (Step S1004).

If the HOV attribute of the traveling lane is “exclusive”, the route search part 1107 advances the processing to the below-described Step S1007, to perform a route search giving priority to an HOV lane. If the HOV attribute of the traveling lane is “none”, the route search part 1107 advances the processing to the below-described Step S1006, to perform a route search without using an HOV lane. If the HOV attribute of the traveling lane is “shared”, then the lane recognition part 1105 judges whether the vehicle is traveling in an HOV lane or not by using an image taken by the camera 1012 (Step S1005).

If it is judged, by using the image taken by the camera 1012, that the vehicle is traveling in an HOV lane (“Yes” in Step S1005), the route search part 1107 advances the processing to the below-described Step S1007, to perform a route search giving priority to an HOV lane.

If it is judged, by using the image taken by the camera 1012, that the vehicle is not traveling in an HOV lane (“No” in Step S1005), the route search part 1107 advances the processing to the below-described Step S1006, to perform a route search without using an HOV lane.

If the HOV attribute of the traveling lane is “none” (“none” in Step S1004), or if it is judged, by using the image taken by the camera 1012, that the vehicle is not traveling an HOV lane (“No” in Step S1005), then the route search part 1107 performs a route search without using an HOV lane. Then, the route guidance part 1108 performs guidance along the recommended (Step S1006). In detail, the route search part 1107 specifies a link cost of each link irrespective of the value of the HOV attribute 1228 of that link, performs a search for a route from the departure plane or the current location to the destination set in Step S1001, and sets a favorable-cost route (for example, the least-cost route) as a recommended route. Then, the route guidance part 1108 guides the user along the recommended route.

If the vehicle is allowed to travel in an HOV lane (“Yes” in Step S1003), or the lane in which the vehicle is traveling is an HOV lane (“exclusive” in Step S1004 or “Yes” in Step S1005), the route search part 1107 searches for a route that gives priority to traveling in an HOV lane. Then, the route guidance part 1108 performs guidance (Step S1007). In detail, as for a link whose HOV attribute 1228 is “exclusive” or “shared” (i.e. a road including an HOV lane), the route search part 1107 performs a route search by using a value obtained by multiplying a link cost (for example, a link travel time) by a prescribed coefficient (for example, a prescribed value such as “0.7”).

When guidance along the route is started, the route guidance part 1108 identifies the current location by obtaining the current location identified by the main control part 1101 (Step S1008). Then, the route guidance part 1108 judges whether the vehicle has arrived at the destination or not (Step S1009). If the vehicle has arrived at the destination (“Yes” in S1009), the route guidance part 1108 ends the route search processing. If the vehicle has not arrived at the destination (“No” in S1009), the route guidance part 1008 judges whether the current location is deviated from the recommended route or not (Step S1010). If the current location is not deviated from the recommended route (“No” in Step S1010), the route search part 1107 returns the processing to Step S1008. If the current location is deviated from the recommended route (“Yes” in step S1010), the route search part 1107 return the processing to Step S1007, to search for a recommended route again.

Hereinabove, the content of the route search processing has been described. By performing the above-described route search processing, the navigation device 1100 can search for a recommended route that uses preferentially an HOV lane, if the situation allows use of an HOV lane. Thus, the navigation device 1100 can perform guidance preferentially along a route that uses an HOV lane.

In the above-described processing, it is judged whether the vehicle is allowed to travel in an HOV lane, just after setting a destination. The invention, however, is not limited to this. For example, when opening and closing of a door of the vehicle 1300 is detected during route guidance, there is a possibility of a change in the number of passengers. In that case, it may be judged once again whether traveling in an HOV lane is possible or not.

According to the above-described route search processing, it is possible to perform a route search by giving priority to a road having an HOV lane. However, it may occur that the retrieved route forces traveling at a location in which entrance/exit between an HOV lane and an ordinary lane is not allowed. As processing for correcting this, HOV-priority route verification processing will be described referring to FIG. 7.

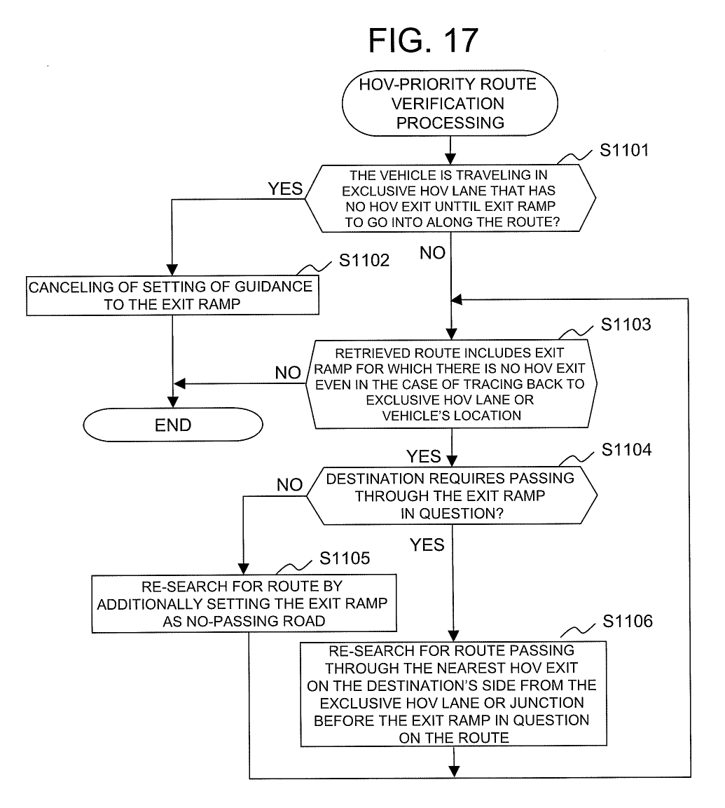

FIG. 17 is a flowchart showing the content of the HOV-priority route verification processing. This flow is started after the route has been searched for and before the guidance is started in Step S1007 of the route search processing.

First, the route verification part 1109 judges whether the vehicle is traveling in an exclusive HOV lane having no exit from the HOV lane until the exit ramp to go into along the route (Step S1101). In detail, the route verification part 1109 extracts the exit ramp as the exit from the road having the HOV lane, out of the information on the recommended route retrieved by the route search part 1107. Then, the route verification part 1109 judges whether the HOV attributes 1228 of the roads included in the recommended route from the departure place or the current location to the exit ramp in question are all “exclusive” or not. If all the attributes are “exclusive” to HOV, it is judged that the vehicle is traveling in an exclusive HOV lane.

If the vehicle is traveling in an exclusive HOV lane (“Yes” in Step S1101), the route verification part 1109 cancels setting of guidance to the exit ramp in question (Step S1102). In detail, the route verification part 1109 sets up the route guidance part 1108 not to perform guidance to the exit ramp in question on the recommended route up to the exit ramp. Then, the route verification part 1109 ends the HOV-priority route verification processing. Here, it is not limited to the above-described case where the route verification part 1109 sets a range in which guidance is not performed. But, the route verification part 1109 may set another range as a range in which guidance is not performed. That is to say, the route verification part 1109 sets up the route guidance part 1108 at least not to perform guidance for the exit ramp in question (i.e. a road to go into just after exiting from the HOV lane at the lane change prohibition section).

If the vehicle is not traveling in an exclusive HOV lane (“No” in Step S1101), the route verification part 1109 judges whether the retrieved route includes an exit ramp for which there is no HOV lane exit even in the case of tracing back to the exclusive HOV lane or the vehicle's location (Step S1103). In detail, the route verification part 1109 extracts exit ramps from the recommended route retrieved by the route search part 1107. Then, for each exit ramp, and as for a shorter one of the two sections, i.e. the section from the exit ramp in question to the start location (the departure place or the current location) of the route and the section from the exit ramp in question to a link having the exclusive HOV attribute, the route verification part 1109 judges whether the section includes an HOV lane exit (i.e. an exit from an HOV lane that does not include a link of the HOV attribute “shared-dashed line”). Then, in the case where the extracted exit ramps include at least one exit ramp for which there is no HOV lane exit between the exit ramp in question and the start location or the link having the exclusive HOV attribute, the route verification part 1109 judges that the retrieved route includes such an exit ramp for which there is no HOV lane exit.

If the retrieved route does not include an exit ramp for which there is no HOV lane exit (“No” in Step S1103), the route verification part 1109 judges that the recommended route in question has no problem, and ends the HOV-priority route verification processing.

If the retrieved route includes an exit ramp for which there is no HOV lane exit (“Yes” in Step S1103), the route verification part 1109 judges whether it is necessary to pass through the exit ramp in question for which there is no HOV lane exit to go to the destination (Step S1104). In detail, if the only route leading to the destination passes through the exit ramp in question, the route verification part 1109 judges that, to go to the destination, it is necessary to pass through the exit ramp for which there is no HOV lane exit. For example, this is true in the case of facilities that cannot be entered without using the exit ramp.

If it is not necessary to pass through the exit ramp for which there is no HOV lane exit (“No” in Step S1104), the route verification part 1109 instructs the route search part 1107 to perform again a route search by setting the exit ramp in question as a no-passing road or setting a sufficiently-large value for the link cost of the exit ramp (for example, by adding a prescribed value to the link cost or by weighting the link cost with a coefficient larger than 1) (Step S1105). Then, the route verification part 1108 returns the control to Step S1103.

If it is necessary to pass through the exit ramp for which there is no HOV lane exit (“Yes” in Step S1104), the route verification part 1109 specifies the nearest HOV lane exit (link having the HOV attribute of “shared-dashed line”) that exists in the traveling direction (on the destination's side) from the HOV lane (i.e. the nearest exclusive HOV lane on the side of the departure place or the current location) or the junction before the exit ramp in question on the recommended route, and instructs the route search part 1107 to search for a route that passes through the specified HOV lane exit (Step S1106). Then, the route verification part 1109 returns the control to Step S1103.

Hereinabove, the content of the HOV-priority route verification processing has been described. By performing the above-described HOV-priority route verification processing, the navigation device 1100 can correct a route that requires traveling at a location where entrance and exit between an HOV lane and an ordinary lane are not allowed. Thus, the navigation device 1100 can perform guidance along a suitable route including a lane (an HOV lane) in which vehicles satisfying specific conditions are allowed to travel.

The above-described processing repeats re-search until an appropriate route is found. However, it may be arranged that, when an appropriate route is not found even after re-search is performed a prescribed number of times (for example, ten times), the setting of guidance is canceled and the guidance is limited to only displaying of the recommended route. By doing this, it is possible to limit processing load of the route search processing of high computational load, and to prevent degradation of the response speed of the navigation device 1100.

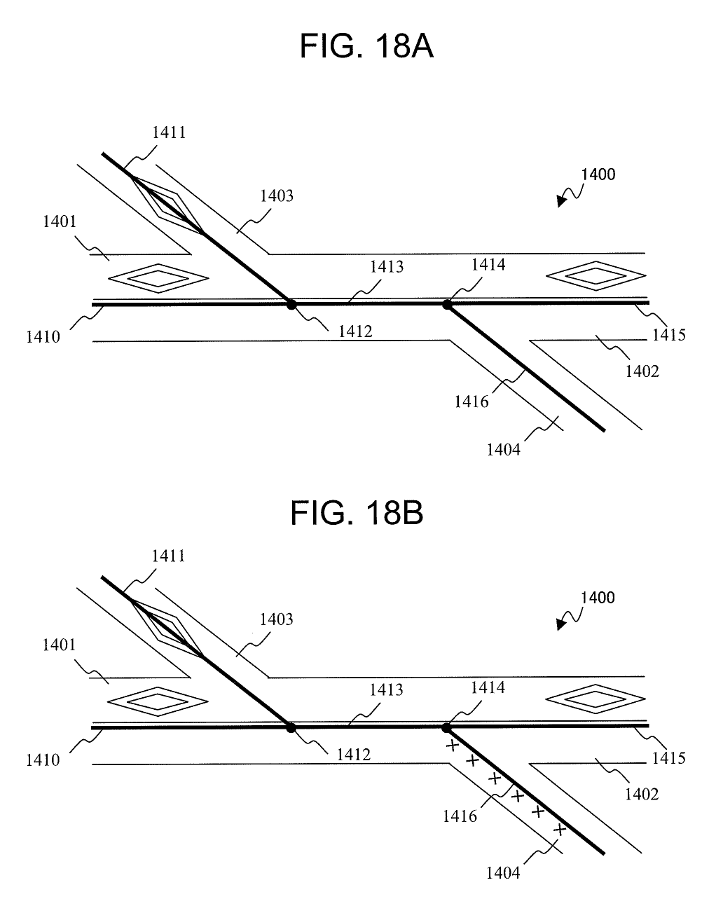

FIGS. 18A and 18B are views illustrating the HOV-priority route verification processing with a specific example. FIG. 18A shows an example of a road 1400 composed of an HOV lane 1401 and an ordinary lane 1402. It is assumed that lane change is not allowed between the HOV lane 1401 and the ordinary lane 1402 in the range shown in the figure. The road 1400 is provided with an entrance ramp 1403 merging into an HOV lane 1401 of the road and an exit ramp 1404 separating from the ordinary lane 1402 of the road 1400 at a location beyond (i.e. on the destination of) the entrance ramp 1403. The road 1400 comprises a link 1410, a link 1413 ahead of that link 1410, and a link 1415 in turn ahead of the link 1413. The link 1410 and the link 1413 are connected at a node 1412, and the link 1413 and the link 1415 are connected at a node 1414. Further, the node 1412 is connected with a link 1411 that forms the entrance ramp 1403, and the node 1414 is connected with a link 1416 that forms the exit ramp 1404. Thus, at a glance, it seems possible to travel along a recommended route passing through the link 1411, the link 1413 and the link 1416 from the viewpoint of the configuration of the links and nodes. In fact, however, it is prohibited to move between the HOV lane 1401 and the ordinary lane 1402, making it impossible to cross the border between the lanes, and thus such a recommended route is unsuitable for traveling.

FIG. 18B is a view showing an example of a road 1400 similar to that in FIG. 18A. In this example, the exit ramp 1404 is set as a no-passing road in Step S1105. By this setting, it is possible to prevent a re-searched route from leading through the node 1414 to the link 1416, i.e. toward the exit ramp 1404. Thus, it is possible to search for a recommended route that does not require a lane change from the HOV lane 1401 to the ordinary lane 1402.

Hereinabove, an embodiment relating to the second point of the invention has been described. According to the above-described embodiment relating to the second point of the invention, it is possible to perform guidance along a suitable route including a lane (an HOV lane) in which vehicles satisfying specific conditions are allowed to travel.

The present invention is not limited to the above-described embodiment. The above-described embodiment relating to the second point of the invention can be varied variously within the spirit and scope of the invention. For example, the lane recognition processing by the lane recognition part 1105 may be performed on the basis of high-precision location information of GPS or information received from oscillators laid on each lane for lane recognition.

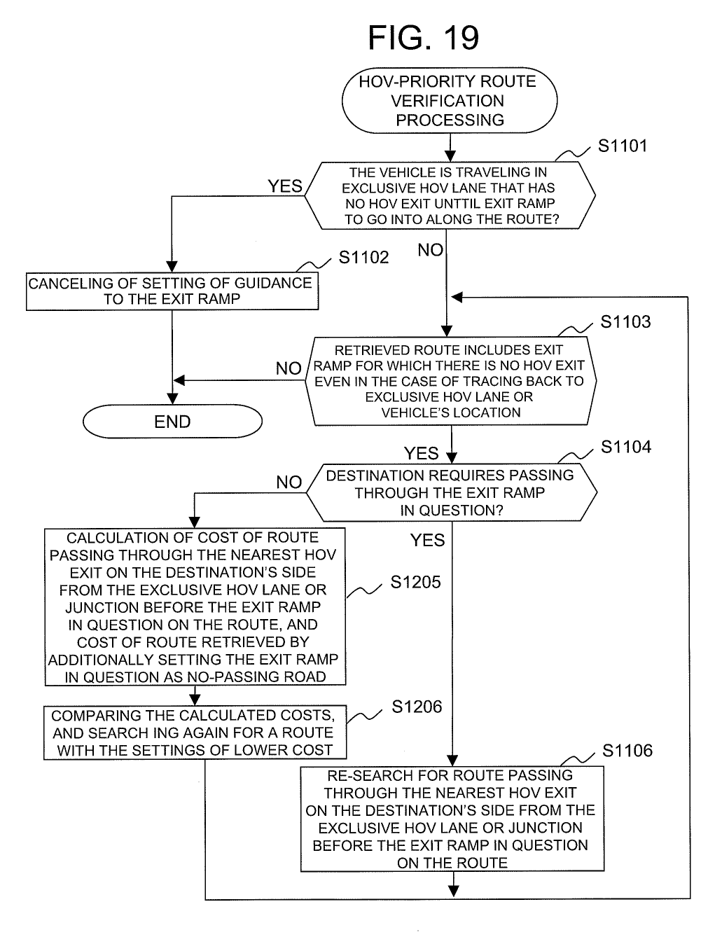

Further, the HOV-priority route verification processing of the above-described embodiment may be varied as shown in FIG. 19. FIG. 19 is a flowchart showing a variation of the HOV-priority route verification processing. This variation has basically-same structure as that of the above-described embodiment, but is different in the processing performed in the case where Step S1104 shows that the destination does not require passing through the exit ramp (i.e. the case of “No” in Step S1104). In the following this difference will be described.

If it is not necessary to pass through the exit ramp for which there is no HOV lane exit (“No” in Step S1104), the route verification part 1109 specifies the nearest HOV lane exit (link having the HOV attribute of “shared-dashed line) that exits in an HOV lane before the exit ramp on the recommended route (i.e. the nearest exclusive HOV lane on the departure place's side or the current location's side) or exits in the traveling direction (on the destination's side) from the junction, and calculates the cost of a route that passes through the HOV lane exit in question. Further, on the other hand, the route verification part 1109 calculates the cost of a route that has been searched for again by setting the exit ramp in question as a no-passing road or setting the link cost of the exit ramp to a sufficiently-large value (Step S1205). Then, the route search part 1109 compares the costs (calculated in Step S1205) of the routes with each other, and searches for a route with the setting of lower cost (Step S1206). Then, the route verification part 1109 returns the control to Step S1103.

Hereinabove, a variation of the HOV-priority route verification processing has been described. According to the above-described variation, it is possible to search again for a route whose cost is lower than that of the structure shown in the first embodiment. Thus, it is possible to perform guidance along a route that is more preferable to the user.

Further, if, in the HOV-priority route verification processing, the recommended route includes a lane change prohibition section, it is possible to perform again a search for a route so as not to include an HOV lane, instead of performing again a search for a route that avoid traveling at a location (lane change prohibition section) where the recommended route crosses over a lane change prohibition part of an HOV lane. By doing so, it is possible to increase the possibility of determining a route that allows at least traveling, even if there is a high possibility that the recommended route includes a lane change prohibition section.

According to the above-described embodiment relating to the second point of the invention, it is possible to arrange that the navigation device does not perform traveling guidance for exiting from an exit ramp in the case where a route is set so as to exit from an HOV lane to the exit ramp without passing through an HOV lane exit, although the navigation device performs traveling guidance at an exit ramp in the case of an ordinary route. Thus, it is possible to avoid guidance along an unsuitable route.

Hereinabove, the present invention has been described centering on embodiments. In the above embodiments, examples of applying the invention to a navigation device have been described. However, the present invention is not limited to a navigation device, and can be generally applied to a device that performs route guidance for a moving body.

1. A navigation device, comprising:
a storage unit adapted to store, for each prescribed section of a road, lane information including information on possibility of entry and exit to and from a lane (hereinafter, referred to as conditional lane) that is available for traveling when prescribed conditions are satisfied;
a route search unit adapted to search for a recommended route to a designated destination; and
a lane guidance unit adapted to perform guidance about entrance into or exit from the conditional lane at a road section that allows entrance and exit to and from the conditional lane; and
if there are an exit-allowing section from the conditional lane and an entrance-allowing section into the conditional lane before the exit-allowing section on the recommended route, the lane guidance unit performs entrance guidance into the conditional lane at the entrance-allowing section.

2. A navigation device according to claim 1, wherein:
the lane guidance unit further performs exit guidance from the conditional lane at the exit-allowing section.

3. A navigation device according to claim 1, wherein:
the lane guidance unit specifies, as the exit-allowing section, a section closer to the destination among sections that allow exiting from the conditional lane on the recommended route.

4. A navigation device according to claim 3, wherein:
the lane guidance unit performs neither the exit guidance nor entrance guidance if there is no section that allows entering into the conditional lane before the exit-allowing section on the recommended route.

5. A navigation device according to claim 1, wherein:
the navigation device further comprises a traveling lane judgment unit adapted to make judgment about a traveling lane; and
the lane guidance unit stops the exit guidance in the case where entrance into the conditional lane is detected by the traveling lane judgment unit after performing the entrance guidance, and exit from the conditional lane is detected before reaching the exit-allowing section.

6. A navigation device according to claim 5, wherein:
in the case where the exit guidance has been stopped and there are an exit-allowing section from the conditional lane and an entrance-allowing section into the conditional lane before the exit-allowing section among remaining section on the recommended route, the lane guidance unit performs again the entrance guidance into the conditional lane at the entrance-allowing section.

7. A guidance method of a navigation device, wherein:
the navigation device comprising:
a storage unit adapted to store, for each prescribed section of a road, lane information including information on possibility of entry and exit to and from a lane (hereinafter, referred to as conditional lane) that is available for traveling when prescribed conditions are satisfied;
a route search unit adapted to search for a recommended route to a designated destination; and
a lane guidance unit adapted to perform guidance about entrance into or exit from the conditional lane at a road section that allows entrance and exit to and from the conditional lane; and
the lane guidance unit carries out a step, in which if there are an exit-allowing section from the conditional lane and an entrance-allowing section into the conditional lane before the exit-allowing section on the recommended route, the lane guidance unit performs entrance guidance into the conditional lane at the entrance-allowing section.

8. A navigation device, comprising:
a storage unit adapted to store lane information including information on a setting-up state of a lane (hereinafter, referred to as conditional lane) that is available for traveling when prescribed conditions are satisfied;
a route search unit adapted to perform a search for a recommended route to a destination by using the lane information; and
a route verification unit adapted to verify whether the recommended route retrieved by the route search unit includes a lane change prohibition section (i.e. a section other than an exit from the conditional lane) through which it is necessary to exit from the conditional lane; and
in the case where the recommended route includes the lane change prohibition section, the route search unit performs again a search for a route that avoids the lane change prohibition section.

9. A navigation device according to claim 8, wherein:
in the case where the recommended route includes the lane change prohibition section, the route search unit performs a search again while forbidding traveling in a road to enter just after exiting from the conditional lane at the lane change prohibition section.

10. A navigation device according to claim 8, wherein:
the route search is performed based on link costs; and
in the case where the recommended route includes the lane change prohibition section, the route search unit performs a search again by increasing a link cost by a prescribed amount with respect to a road to enter just after exiting from the conditional lane at the lane change prohibition section.

11. A navigation device according to claim 8, wherein:
in the case where the recommended route includes the lane change prohibition section, the route search unit performs again a search for a route that passes through a nearest exit from the conditional lane on a destination's side in relation to a road traveled just before exiting from the conditional lane at the lane change prohibition section.

12. A navigation device according to claim 8, wherein:
in the case where the recommended route includes the lane change prohibition section,
if it is necessary for reaching the destination to pass through a road to enter just after exiting from the conditional lane at the lane change prohibition section, the route search unit performs again a search for a route that passes through a nearest exit from the conditional lane on a destination's side in relation to a road traveled just before exiting from the conditional lane at the lane change prohibition section; and
if it is not necessary for reaching the destination to pass through the road to enter just after exiting from the conditional lane at the lane change prohibition section, the route search unit performs a search again while forbidding traveling in the road to enter just after exiting from the conditional lane at the lane change prohibition section.

13. A navigation device according to claim 8, wherein:
the route search is performed based on link costs; and
in the case where the recommended route includes the lane change prohibition section, the route search unit compares a link cost of a route retrieved by forbidding traveling in the road to enter just after exiting from the conditional lane at the lane change prohibition section with a link cost of a route retrieved as a route passing through a nearest exit from the conditional lane on a destination's side in relation to a road traveled just before exiting from the conditional lane at the lane change prohibition section, and sets a route of a more favorable cost as a recommended route.

14. A navigation device according to claim 8, wherein:
the route search is performed based on link costs; and
in the case where the recommended route includes the lane change prohibition section and it is not necessary for reaching the destination to pass through a road to enter just after exiting from the conditional lane at the lane change prohibition section,
the route search unit compares a link cost of a route retrieved by forbidding traveling in the road to enter just after exiting from the conditional lane at the lane change prohibition section with a link cost of a route retrieved as a route passing through a nearest exit from the conditional lane on a destination's side in relation to a road traveled just before exiting from the conditional lane at the lane change prohibition section, and sets a route of a more favorable cost as a recommended route.

15. A navigation device according to claim 14, wherein:
in the case where it is necessary for reaching the destination to pass through a road to enter just after exiting from the conditional lane at the lane change prohibition section, the route search unit searches for a route passing through a nearest exit from the conditional lane on a destination's side in relation to a road traveled just before exiting from the conditional lane at the lane change prohibition section.

16. A navigation device, comprising:
a storage unit adapted to store lane information including information on a setting-up state of a lane (hereinafter, referred to as conditional lane) that is available for vehicles satisfying specific conditions;
a route search unit adapted to perform a search for a recommended route to a destination by using the lane information;
a route guidance unit adapted to perform guidance along the recommended route retrieved by the route search unit; and
a route verification unit adapted to verify whether the recommended route includes a lane change prohibition section (i.e. a section other than an exit from the conditional lane) through which it is necessary to exit from the conditional lane; and
in the case where the recommended route includes the lane change prohibition section, the route guidance unit does not perform guidance at least about a road to enter just after exiting from the conditional lane among roads included in the recommended route.

17. A route search method of a navigation device, wherein:
the navigation device comprises:
a storage unit adapted to store lane information including information on a setting-up state of a lane (hereinafter, referred to as conditional lane) that is available for traveling when prescribed conditions are satisfied;
a route search unit adapted to perform a search for a recommended route to a destination by using the lane information; and
a route verification unit adapted to verify whether the recommended route retrieved by the route search unit includes a lane change prohibition section (i.e. a section other than an exit from the conditional lane) through which it is necessary to exit from the conditional lane; and
the route search unit carries out a step, in which in the case where the recommended route includes the lane change prohibition section, the route search unit performs again a search for a route that avoids the lane change prohibition section.
